(19) United States
(12) Patent Application Publication
(10) Pub. No.: US 2011/0044846 A1
(43) Pub. Date: Feb. 24, 2011

(54) REGISTER VENT FILTER

(76) Inventors: DAVID MCNALLY, Sparks, NV (US); Michelle Solorio, Sparks, NV (US); Kim Kalbaugh, Blairsden, CA (US)

Correspondence Address: LAW OFFICE OF JERRY D. HAYNES , P.A, P.O. Box 350392, Fort Lauderdale, FL, 33335, US

(21) Appl. No.: 12/545,979

(22) Filed: Aug. 24, 2009

(51) Int. Cl. B01D 53/74

(52) U.S. Cl. 422/4; 96/226

(57) ABSTRACT

The present invention relates to an air filter assembly and a method of using the same on a register vent comprising: a mechanism to attach the filter to an inside perimeter of the register; a sleeve to allow for the insertion of register louvers; and a filter where said filter includes an anti-bacteria agent. The mechanism to attach may include an adhesive strip. The anti-bacteria agent disinfects and deodorizes airflow through the register. The anti-bacteria agent effectively removes bacteria and fungi from the airflow through the register.

### BACKGROUND OF THE INVENTION

1. Field of Invention

The present invention relates to a filter for a register vent to provide a means to disinfect and filter air in an HVAC system.

2. Description of Related Art

Maintenance of indoor air quality is a primary concern of both homeowners and commercial building operators in order to provide a suitable environment for habitation. Indoor air handling is usually controlled through the use of HVAC systems that include a filtering means. The means of air filtration may include the use of air filters that are provided in return duct systems and air filters that are placed in duct systems that provide a means to filtrate air emitted through the HVAC system. Lack of proper air filtration can cause environmental hazards within the indoor environment. Such hazards may include fungus, bacteria, allergic fungi and other abnormalities may collect and grow within the ducting system of HVAC system. These types of hazards may induce health problems such as allergic conditions, exacerbate asthma conditions and spread airborne diseases and pathogens. Without appropriate and proper indoor air circulation then these types of hazards could spread throughout a home or building.

One method of filtrating air includes the application of a filter across a register vent that may be placed in a home or a building. Placement of register filters has been implemented in the prior art. In particular, U.S. Pat. No. 6,361,578 includes an air duct filter frame that is installed on the surface of an existing grill through the use of a magnetic backing therefore adhering on the front surface of the register grill. Further development in the area of filtration is necessary to provide effective means to diminish air borne pathogens and bacteria within a home or building.

### SUMMARY OF THE INVENTION

The present invention relates to an air filter assembly for use on a register vent comprising: a means to attach the filter to an inside perimeter of the register; a sleeve to allow for the insertion of register louvers; and a filter where said filter includes an anti-bacteria agent. The means to attach may include an adhesive strip. The anti-bacteria agent provides a means to disinfect and deodorize airflow through the register. The anti-bacteria agent effectively removes bacteria and fungi from the airflow through the register.

Furthermore, the present invention includes a method for disinfecting and deodorizing airflow through a register vent comprising the steps of: removing a register vent from a duct; inserting an air filter assembly on the inside surface of the register vent, where said filter assembly includes a means to attach the filter to the inside perimeter of the register vent and a filter where said filter includes an anti-bacteria agent; and replacing the register vent onto the duct with the filter assembly attached.

### BRIEF DESCRIPTION OF DRAWINGS

FIG. 1 depicts a prospective view of an air filter assembly according to the present invention.

FIG. 2 depicts a side view of the air filter assembly according to the present invention.

### DETAILED DESCRIPTION

The present invention provides an air filter designed for implementation on a register vent. The present invention includes an adhesive portion that provides a means to attach the filter to the inside perimeter of the register. In addition to the adhesive strip, the filter includes a sleeve portion to allow for the insertion of register louvers that may exist. The filter according to the present invention includes an odorless anti-bacteria agent with a non-drying adhesive for particle collection that filters the air transmitted through the register vent.

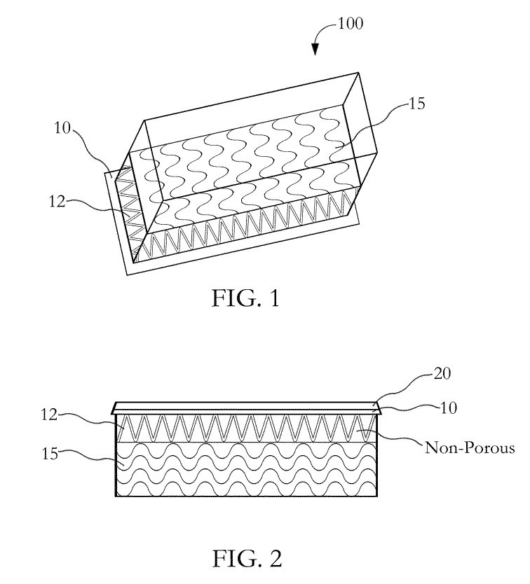

FIG. 1 depicts an air filter according to the present invention. The Air Filter Assembly 100 contains an adhesive Strip 10 around the perimeter of the filter assembly. The adhesive Strip 10 provides a means to attach the filter assembly onto the inside portion of the register vent. The Air Filter Assembly 100 further includes a Sleeve 12 that provides a means to allow for the louver depth of the register vent. Above the Sleeve 12 a Filter 15 is provided. The Filter 15 contains an anti-bacterial agent that filters and removes bacteria or fungi that may exist within the air that transmits through the vent. The Air Filter 15 filters, deodorizes and disinfects the air and helps to diminish pet odors, dandruff or other common household particles that may transmit through the HVAC system.

FIG. 2 provides a side view of the Air Filter Assembly 100. The side view provides a clearer view of the Sleeve 12 and Filter 15. The Sleeve 12 is an open non-porous area of the Assembly 100. The adhesive Strip 10 is also more clearly visible as it adheres to a perimeter portion of a Register Vent 20. The density of the Air Filter 15 allows for the lowest possible airflow restriction in order not to reduce airflow through the register vent.

The present invention creates a cleaner and more livable environment for the user thereof. Further the Air Filter Assembly 100 according to the present invention may be easily installed and effective in any HVAC system. The register vent is removed from its position and then the Air Filter Assembly 100 is placed on the inside portion of the register vent. After the placement of the filter assembly, the register vent is put back in place and the HVAC system is ready for use.

The instant invention has been shown and described in what is considered to be the most practical and preferred embodiments. It is recognized, however, that departures may be made there from within the scope of the invention and that obvious modifications will occur to a person skilled in the art.

What is claimed is:

1. An air filter assembly for use on a register vent comprising:
a. a means to attach the filter to an inside perimeter of the register;
b. a sleeve to allow for the insertion of register louvers; and
c. a filter where said filter includes an anti-bacteria agent.

2. The air filter assembly according to claim 1, where said means to attach includes an adhesive strip.

3. The air filter assembly according to claim 1, where said anti-bacteria agent provides a means to disinfect and deodorize airflow through the register.

4. The air filter assembly according to claim 1, where said anti-bacteria agent removes bacteria and fungi from the airflow through the register.

5. A method for disinfecting and deodorizing airflow through a register vent comprising the steps of:
a. removing a register vent from a duct;
b. inserting an air filter assembly on the inside surface of the register vent, where said filter assembly includes a means to attach the filter to the inside perimeter of the register vent and a filter where said filter includes an anti-bacteria agent; and
c. replacing the register vent onto the duct with the filter assembly attached.
